(19) United States
(12) Patent Application Publication
(10) Pub. No.: US 2019/0102620 A1
(43) Pub. Date: Apr. 4, 2019

(54) SYSTEMS AND METHODS FOR DETECTING SEMANTICS OF COLUMNS FROM TABULAR DATA

(71) Applicant: Rovi Guides, Inc., San Carlos, CA (US)

(72) Inventors: Abubakkar Siddiq, Methuen, MA (US); Ganesh Ramamoorthy, Andover, MA (US); Sankar Ardhanari, Windham, NH (US); Sai Rahul Reddy Pulikunta, North Andover, MA (US)

(21) Appl. No.: 15/720,776

(22) Filed: Sep. 29, 2017

(51) Int. Cl. G06K 9/00; G06F 17/30

(52) U.S. Cl. CPC G06K 9/00469; G06F 17/30528; G06K 9/00449

(57) ABSTRACT

Systems and methods for detecting the semantics for columns in tabular data automatically in electronic documents. For example, a media guidance application may receive an electronic document that may contain a table relating to television program schedules. The media guidance application may then detect data rows that form the records of the table, and determine the column type for every column in the table to extract television program schedule information.

### BACKGROUND

Electronic documents may contain tabular data such as a table in the form of a grid of cells of values. The tabular data may encode and present records of content and/or information in a grid, where each row of the grid represents a record, and each column within the row encodes an attribute or field value within the record into each individual cell. For example, a tabular document of a television program schedule may have a number of rows. Each row of the table represents a broadcast schedule of a television program, and each column within a respective value includes a cell value describing a particular characteristic of the television program, such as original title, Spanish title, genre, year, rating, air time, and/or the like. To obtain information from the table of television program, conventional parsing tools are configured with parsing rules or parameters to read each column or row of the table. For example, values within the column representing “original title” are to be saved as text strings, while values within the column “air time” are to be saved in a data format for date and time. To parse the tabular data, conventional parsing tools are built upon the knowledge of what the data in each column represents. When the table contains elements that have not been defined by the existing rules or parameters of the parsing tool, e.g., a “FOX1” acronym in the television program table, conventional parsing tools may not be able to decode and place such content into a relevant column or cell.

### SUMMARY

Systems and methods are disclosed herein for detecting the semantics for columns in tabular data automatically in electronic documents. For example, a media guidance application may receive an electronic document that contains a table relating to television program schedules. The media guidance application may then detect data rows that form the records of the table, and determine the column type for every column in the table to extract television program schedule information and save extracted data from the data table in a corresponding data format based on the column type. In this way, the media guidance application no longer needs previously coded rules that establish data formats and semantics of data types to read each row and column of a data table, but may automatically determine the semantics of each column, even when the data type of a column is new to the media guidance application

To this end and others, in some aspects of the disclosure, the media guidance application may receive an electronic document containing a grid. The media guidance application may determine whether the grid contains tabular data. For example, the media guidance application may determine whether the grid corresponds to a table object defined in a structured document model. In response to determining that the grid does not correspond to a table object defined in a structured document model, the media guidance application may determine whether the grid contains a number of rows and a number of columns that are compliant with a table format. In response to determining that the grid contains a number of rows and a number of columns that are compliant with a table format, the media guidance application may translate the grid to tabular data in a form of the table object.

In response to determining that the grid contains tabular data, the media guidance application may identify a plurality of rows and a plurality of columns from the tabular data. The media guidance application may determine whether a portion of the plurality of rows that share the same data type exceeds a pre-defined percentage, e.g., whether the majority of the data rows has the same data type such that the column may reflect a semantics type of data.

For example, for each column, the media guidance application may retrieve a plurality of data values that belong to the column from the plurality of rows in the grid. For each data value from the plurality of data values, the media guidance application may identify a data format corresponding to the data value, and map the data format to a pre-defined data type that characterizes the data value. The media guidance application may then determine a total count of rows that share the same pre-defined data type corresponding to the column. The media guidance application may determine a maximum total count of rows that share the same pre-defined data type among the plurality of columns, and determine whether the maximum total count of rows divided by a total number of the plurality of rows exceeds the pre-defined percentage.

If at least a portion of the plurality of rows that share the same data type exceeds the pre-defined percentage, the media guidance application may compare a first row of the grid with other rows of the grid to determine whether the first row is a header row. For example, the media guidance application may retrieve a first data value in a first row of the grid and a plurality of data values of other data rows in a same column with the first data value. The media guidance application may determine that the first data value corresponds to a first data type. The media guidance application may determine that a subset of the plurality of data values of other data rows correspond to a second data type, and a total count of the subset of the plurality of data values divided by a total number of the plurality of rows exceeds the pre-defined percentage. The media guidance application may compare the first data type with the second data type. In response to determining that the first data type is different from the second data type, the media guidance application may identify the first row of the grid as the header row.

If the first row of the grid has a different data type (e.g., a text string of “Date”) from other rows (e.g., a date string of “Jan. 1, 2017”) of the grid, the media guidance application may identify the first row of the grid as the header row. The media guidance application may determine whether a respective data value in the header row corresponding to a respective column indicates a semantics type of the respective column, e.g., the data value “Date” in the header row describes a semantics type of the column as a calendar date. For example, the media guidance application may query a database of previously stored semantics types based on the respective data value. The media guidance application may obtain one or more previously stored semantics types from the querying. For each obtained previously stored semantics type, the media guidance application may determine whether the obtained previously stored semantics type matches a data type corresponding to data values from the other rows of the grid in the respective column. In response to determining that at least one obtained previously stored semantics type matches the data type corresponding to data values from the other rows of the grid in the respective column, the media guidance application may identify the at least one obtained previously stored semantics type as the semantics type of the respective column.

If the data value from the header row describes a semantics type for the column, the media guidance application may identify a pre-stored data format corresponding to the semantics type, e.g., a format of “MM-DD-YYYY” for the semantics type of a calendar date.

In some embodiments, when the data type of the first row is not different from other rows, or when the data value from the hear row is not descriptive of a semantics type of the column (e.g., a value of “MEX” in the header row is not descriptive of the semantics type, etc.), the media guidance application may query a semantics table to identify one or more semantics types based at least in part on a data type corresponding to at least a subset of the plurality of data values of other data rows. The media guidance application may then refine the one or more semantics types based on a context of the tabular data to determine a semantics type for the respective column.

For example, the media guidance application may extract a plurality of keywords descriptive of the context of the tabular data from textual content of the electronic document, e.g., “broadcast schedule information” from the caption of the table. For each semantic type from the one or more semantics types, the media guidance application may determine an overlap percentage with the plurality of keywords. The media guidance application may then identify a semantics type that has the highest overlap percentage with the plurality of keywords as the semantics type for the respective column.

In some embodiments, the media guidance application may store data values corresponding to each respective column in the data format compliant with the semantics type.

In some embodiments, the media guidance application may identify a first data value from a first row of the column (e.g., “Date” in the header row) and a first set of data values from other rows of the column (e.g., “Jan. 1, 2017”). The media guidance application may search in the previously-built training data set for a sample column that has a second data value in the first row having a same data type as the first data value, or a second set of data values from other rows having a same data type as the first set of data values. The media guidance application may identify the defined semantics type as the semantics type for the column.

In some embodiments, the media guidance application may retrieve a first column having a first data type and a second column having a second data type from the grid. The media guidance application may determine that the first data type and the second data type match a pattern of co-existing semantics types in a table, and may identify a first semantics type for the first column and a second semantics type for the second column based on the pattern of co-existing semantics types. For example, the training data may indicate that such pattern of several adjacent columns under the header row of geographical codes indicate a semantics type of a time in a specific time zone.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative diagram for automatically replaying a portion of a media asset to a user based on a voice alert from another user, in accordance with some embodiments of the disclosure;

FIG. 2 shows an illustrative embodiment of a display screen that may be used to provide media guidance application listings and other media guidance information, in accordance with some embodiments of the disclosure;

FIG. 3 shows another illustrative embodiment of a display screen that may be used to provide media guidance application listings, in accordance with some embodiments of the disclosure;

FIG. 4 is a block diagram of an illustrative user equipment (UE) device in accordance with some embodiments of the disclosure;

FIG. 5 is a block diagram of an illustrative media system in accordance with some embodiments of the disclosure;

FIGS. 6A-6B depict an illustrative flowchart of a process for automatically detecting semantics of columns in a data table to determine a data concept that each column represents, in accordance with some embodiments of the disclosure;

FIG. 7 depicts an illustrative flowchart of a process for determining whether a portion of the plurality of rows that share a same data type exceeds a pre-defined percentage, in accordance with some embodiments of the disclosure;

FIG. 8 depicts an illustrative flowchart of a process for refining one or more semantics types based on a context of the tabular data to determine a semantics type for the respective column, in accordance with some embodiments of the disclosure;

FIG. 9 depicts an illustrative flowchart of a process for determining the semantics type of each column based on a training data set, in accordance with some embodiments of the disclosure; and

FIG. 10 depicts an illustrative flowchart of a process for detecting semantics of columns in a data table, in accordance with some embodiments of the disclosure.

### DETAILED DESCRIPTION

Systems and methods are described herein for automatically detecting the semantics for columns in tabular data in electronic documents. For example, a media guidance application may receive an electronic document that contains a television program schedule. The television program schedule may appear in a form of a grid including a number of rows and a number of columns. Each respective row may represent a television program; and within each respective row, each cell at the intersection of the respective row and a column contains a value, such as but not limited to “FOX1,” “the Kelly File,” “20:30,” “21:30,” and/or the like. The media guidance application may then read and extract the values from the cells, and determine what kind of data each value represents.

In some embodiments, to identify what kind of data the value in each cell within a row represents, the media guidance application may determine whether any data row is a header row, based on which the media guidance application determines the column type for every column in the table. With rows, headers and semantics/type of columns identified, the media guidance application may extract a record, e.g., a television program, which is represented by a respective row and the attributes/fields within the respective row.

In some embodiments, in determining whether a data row is a header row, the media guidance application may optionally identify whether an identified header row contains calendar elements, for example, whether the header row exclusively includes values indicative of a calendar date, such as “Monday,” “Tuesday,” “Wednesday,” “Thursday,” etc. If such a row is present within the table, the media guidance application may treat the table as a calendar, and may read and process a value from a cell based on which column the cell is associated with accordingly. Further detail on determining whether the electronic document, e.g., the header row, contains calendar elements is discussed in co-pending and commonly-assigned U.S. patent application Ser. No. ______ (Attorney docket no. 003597-1681-101), filed on the same day, which is hereby expressly incorporated by reference herein in its entirety.

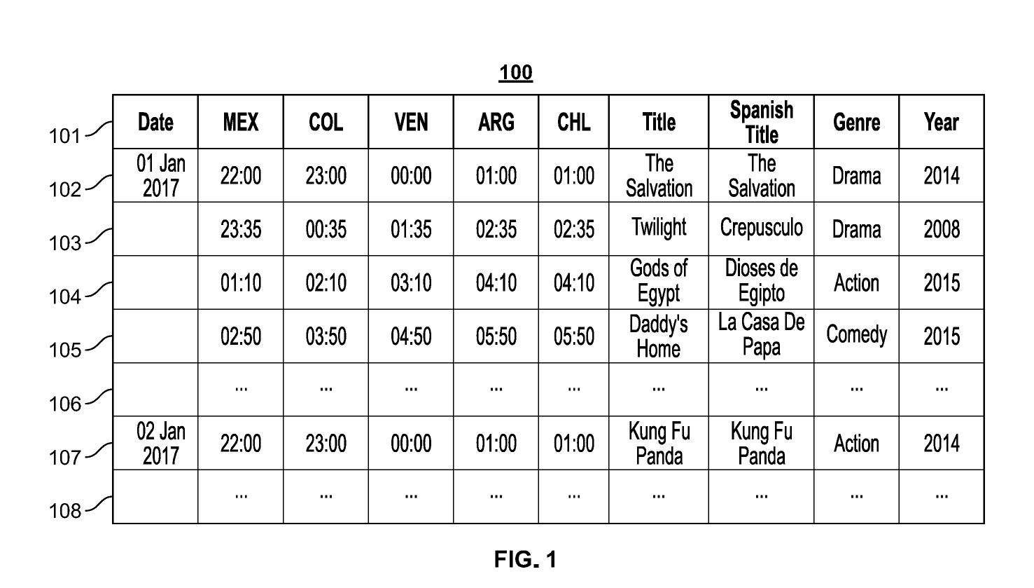

As used herein, the term “semantics” or “semantics” type is defined to mean a data concept that a data values a type of data value correspond to. For example, in a broadcast schedule table (e.g., see table 100 in FIG. 1), the semantics for the data format of date information such as “Jan. 1, 2017” indicates a date when a particular program is aired. As used herein, the term “media guidance application” is defined to mean an application that provides guidance for a user to select or control the playing of a media asset or content. Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

It is to be noted that embodiments described herein may be implemented by a media guidance application, or any other tool that is capable of receiving, and parsing information from an electronic document.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), notification information (e.g., text, images, media clips, etc.), on-demand information, blogs, websites, and any other type of guidance data that is helpful for a user to navigate among and locate desired content selections.

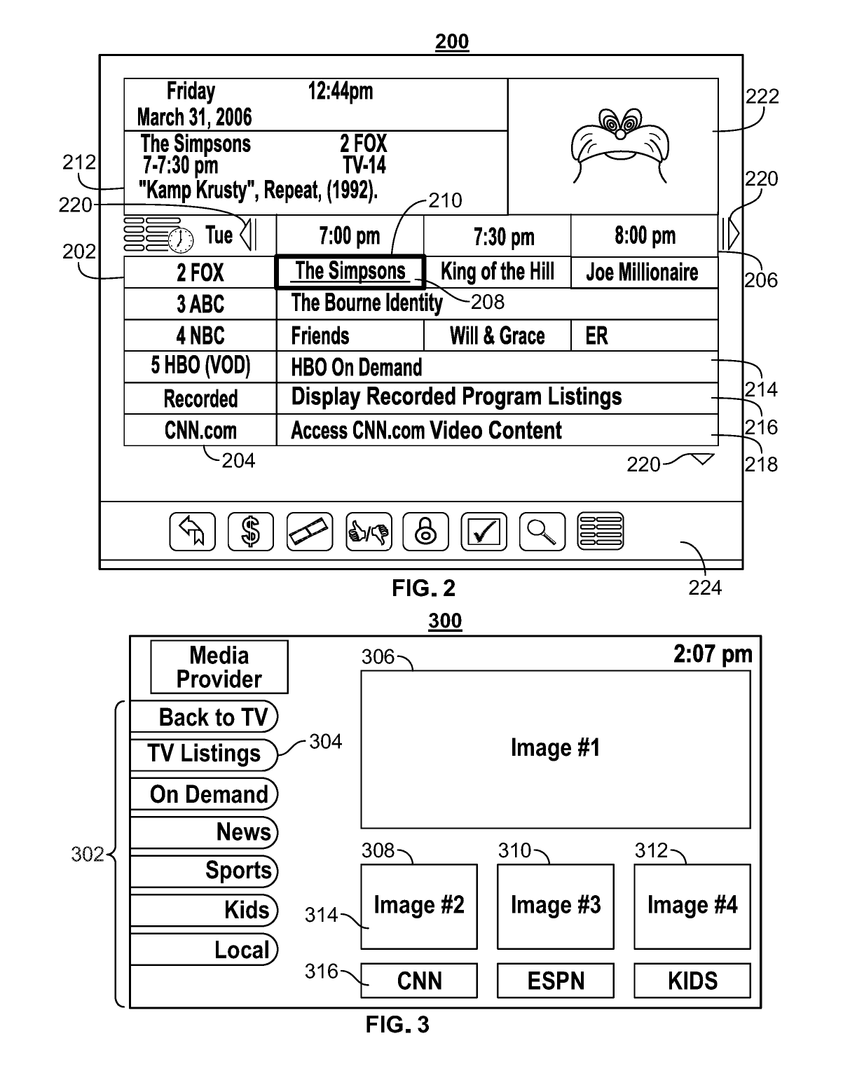

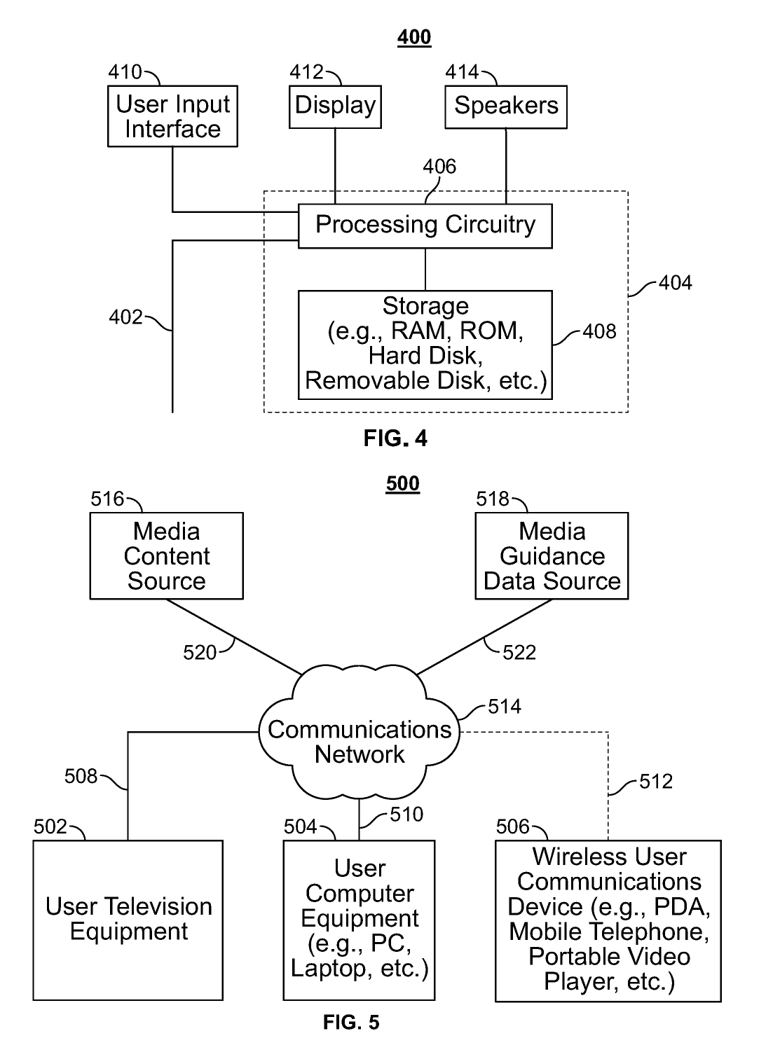

In some embodiments, control circuitry 404, discussed further in relation to FIG. 4 below, executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays discussed in relation to FIGS. 2-3. In some implementations, any action performed by control circuitry 404 may be based on instructions received from the media guidance application.

As referred to herein, the term “in response to” refers to initiated as a result of. For example, a first action being performed in response to a second action may include interstitial steps between the first action and the second action.

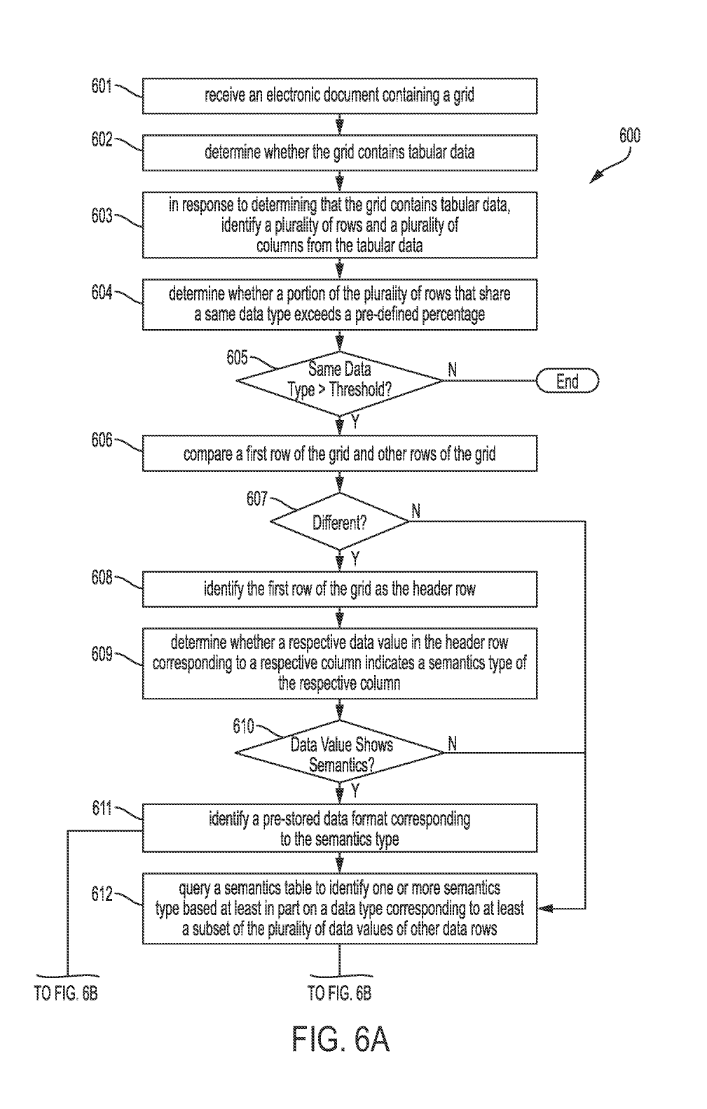

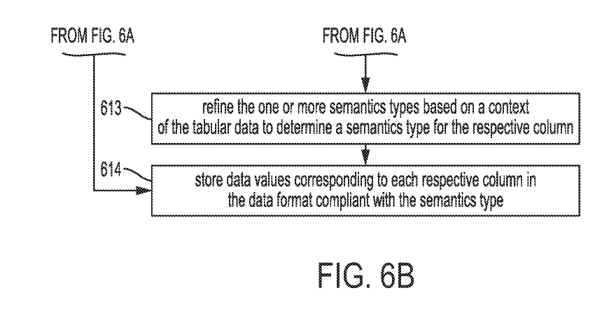

FIG. 1 depicts an illustrative diagram showing an example television program table on which the media guidance application may automatically detect the semantics for columns in the tabular data, in accordance with some embodiments of the disclosure. The media guidance application may receive an electronic document that includes a table similar to 100, e.g., from media guidance data source 518 via communication networks 514 in FIG. 5 as further discussed in relation to FIG. 5. For example, the electronic document may include a format compatible with Microsoft Word, Adobe Acrobat, Microsoft Excel, Powerpoint, a Hypertext Transfer Protocol (HTTP) document, and/or the like.

In some embodiments, the media guidance application may identify tabular data from the electronic document. For example, when the electronic document is an editable document, such as a word document, an excel document, etc., the media guidance application may identify a table object including a number of rows and columns from the document. As another example, when the document is a non-editable document, such as an adobe acrobat PDF document, the media guidance application may perform optical character recognition (OCR) on the document and detect that the document content includes a grid. The media guidance application may then identify the grid as a table containing tabular data, and may optionally format the grid into a table object. For example, the table 100 defined as an HTML table object may take a form similar to the following:

```
<table style=″width:100%″>
  <tr>
    <th>Date</th>
    <th>MEX</th>
    <th>COL</th>
      <th>VEN</th>
    <th>ARG</th>
      ...
  </tr>
  <tr>
    <td>01 JAN 2017</td>
    <td>22:00</td>
    <td>23:00</td>
      ...
  </tr>
  <tr>
    <td>null </td>
    <td>23:35</td>
    <td>00:35</td>
      ...
  </tr>
      ...
</table>
```

In some embodiments, upon the media guidance application identifying a grid or a table within the electronic document, the media guidance application may detect data rows from the table. For example, when the media guidance application obtains a structured table object as described in an example as above, the media guidance application may extract each table row that is defined with the <tr> tag and ends with the </tr> tag.

In some embodiments, multiple rows in table 100 may form the same data row of a table, e.g., rows 102-103, etc. all belong to a row that represents the television program schedule of date “1 Jan. 2017.” The media guidance application may capture a row-signature for each row (e.g., 102-103, etc.) in table 100. The media guidance application may then identify a sequence of rows with the same row-signature as forming data rows of a table. The row-signature is computed using features of text in each of the cells in the row.

For example, the media guidance application may create row (or column) signatures based on features of each cell value in the respective row (or column), such as but not limited to: character parings; character-sets that a textual cell value uses; whether the cell value is alphabetic, alphanumeric, or numeric; whether the cell value is a single word or contains multiple words; whether the cell value is description-like or not, e.g., which may be determined by the number of words used in a cell value, the presence of sentences (marked by sentence delimiters like periods), and presence of prepositions, and/or the like. The media guidance application may further evaluate whether the cell value matches any well-known vocabulary in the domain (e.g., the domain of media assets, etc.), which may then be used to map to a semantic type. For example, cell values such as PG13, R, TV-PG, etc., in the entertainment domain may be mapped to a “ratings” semantic type.

In some embodiments, the media guidance application may determine whether a portion of the plurality of rows that share the same data type exceeds a pre-defined percentage, e.g., whether the majority of the data rows has the same data type such that the column may reflect a semantics type of data. For example, if each row of the tabular data has a different data type, the media guidance application may determine that it is unnecessary to determine a semantics type for a column, as each row may be different.

For each column, the media guidance application may retrieve a plurality of data values that belong to the column from the plurality of rows in the grid. In table 100 as shown in FIG. 1, for the first column, the media guidance application may retrieve the data value of “Date” from the first row, and a list of data values in the format of “dd-MMM-YYYY” in other rows 102-108. For each data value from the plurality of data values, the media guidance application may identify a data format corresponding to the data value, and maps the data format to a pre-defined data type that characterizes the data value. In table 100, the data value of “Date” in row 101 has a data format of a text string, and the text string “Date” is mapped to a data type of a descriptor. The data value of “Jan. 1, 2017” in row 102 has a data format of a calendar date, and the calendar date format is mapped to a date type as schedule-related information. The media guidance application may then determine a total count of rows that share the same pre-defined data type corresponding to the column. The media guidance application may determine a maximum total count of rows that share the same pre-defined data type among the plurality of columns, and determine whether the maximum total count of rows divided by a total number of the plurality of rows exceeds the pre-defined percentage. In this example, as all the rows 102-108, except row 101 has a date type relating to schedule-related information. Thus for the first column, the majority of the data values relate to schedule information.

In some embodiments, the media guidance application may determine whether there is a header row in table 100. For each row (e.g., 101-108, etc.), the media guidance application may select a first row that is placed above all the detected data rows, and extract the value of each cell in the first row, e.g., the data value of “Date” in row 101. The media guidance application may then read a number of data rows that are placed below the first row, and compare the values of cells that belong to the same column with the value in the first row corresponding to the same column.

For example, the media guidance application may read the first row 101 of table 100, and compare the first row 101 with the second row 102 and the third row 103. The media guidance application may determine that cells within the first row 101 contain values of a different data format from those of the second row 102 and the third row 103. For example, for column “MEX,” the cell in the first row 101 contain a text string “MEX,” while cells in the second row 102 and the third row 103 contain data indicative of a time. As such, for the same column, when the first row contains a value of a different data format from other rows, the media guidance application determines that the first row is the header row. Otherwise, if all rows of the table share a consistent data type for every column, the media guidance application determines that there is no header row in the table.

In some embodiments, the media guidance application may identify a header row by performing a match based on lookups in a set of training data, e.g., a corpus of possible header value-to-class mappings. For example, by reading the first row of the table, the media guidance application may determine whether a value in a cell matches a previously stored attribute e as the sema, e.g., such previously stored attribute or filed name may be stored at storage 404 in FIG. 4, or media guidance data source 518, which can be obtained via communication networks 514 in FIG. 5. For example, as shown in table 100, when the media guidance application reads values such as “date,” “MEX,” “title,” “Genre,” “Year,” from the first row 101, the media guidance application may form a query in a database of attribute names based on these values. For example, if the media guidance application determines that the value or term “Date” matches with a previously stored attribute or field Air Date, the media guidance application may identify the column corresponding to “Date” as having a data type corresponding to the previously stored attribute or field Air date. The media guidance application may read and save all values within the column corresponding to “Date” in a data format that corresponds to a calendar date, e.g., DD-MMM-YYYY, etc. Similarly, for another example, if the media guidance application determines the value or term “Title” matches with a previously stored attribute title_of_program, the media guidance application may read and save all values corresponding to the column “Title” as text strings, which correspond to the previously stored attribute title_of_program.

In some embodiments, the media guidance application may further correlate two or more columns to determine the class of a cell value based on past training of some seen header values. For example, upon identifying the column of “MEX” may correspond to a previously stored attribute such as Air_time under a time zone “MEX,” when the media guidance application may probabilistically identify the column of “COL” as similarly corresponding to an air time under a time zone of “COL.”

In some embodiments, the media guidance application may use a pattern of correlated columns that frequently appear together in previously stored training data to identify semantics types of one or more columns. For example, the media guidance application may identify that a column of broadcast dates and a column of broadcast time frequently appear together. In table 100, when the media guidance application identifies a data type of a text string having a format of “DD-MMM-YYYY” in a first column, and a data type of a text string having a format of “XX:XX” in a second column, the media guidance application may identify a pattern of co-existing semantics types such as date and time. For another example, the media guidance application may identify a pattern of several adjacent columns of data types of a text string having a time format of “XX:XX” under the header row of geographical codes such as “MEX,” “COL,” “VEN,” etc., as each indicating a semantics type of a time in a specific time zone.

Another alternative embodiment of identifying the header row is to create a signature vector for each respective row (e.g., generating a hash signature based on values in the first row) and compare the signature vector against a previously stored header-row signature vector.

In some embodiments, if the media guidance application identifies the first row of the grid as the header row, the media guidance application may determine whether a respective data value in the header row corresponding to a respective column indicates a semantics type of the respective column, e.g., the data value “Date” in the header row may describe a semantics type of the column as a calendar date. For example, the media guidance application may query a database of previously stored semantics types based on the respective data value. The media guidance application may obtain one or more previously stored semantics types from the querying. For each obtained previously stored semantics type, the media guidance application may determine whether the obtained previously stored semantics type matches a data type corresponding to data values from the other rows of the grid in the respective column. In response to determining that at least one obtained previously stored semantics type matches the data type corresponding to data values from the other rows of the grid in the respective column, the media guidance application may identify the at least one obtained previously stored semantics type as the semantics type of the respective column. An example semantics table may take a form similar to the following:

TABLE 1
Example Semantics Type Table

| Keyword | Data type | Semantics | Data format |
|---|---|---|---|
| Date, | text string | date | “DD-MM-YYYY,” |
| January, | | | “MM/DD/YYYY,” |
| February, | | | “MMM DD,” . . . |
| March . . . | | | |
| “Time,” “:” | Numeric | time, | “XX:XX,” |
| | | broadcast | “XX′XX″” . . . |
| | | time | |
| “MEX,” | Text string | Geographical | “XXX” |
| “COL,” | | code, time | |
| “VEN,” . . . | | zone | |
| . . . | . . . | . . . | . . . |

In the first column of table 100, the header row 101 has a text string of “Date,” which may be mapped to a semantics of date based on Table 1. Thus, data values in other rows 102-108 below the header row 101 of the first column may be mapped to a data format indicating a date such as “DD-MMM-YYY,” “MM/DD/YYYY,” and/or the like.

In some embodiments, when there is no header row, or when the data value from the hear row is not descriptive of a semantics type of the column (e.g., a value of “MEX” in the header row of table 100 is not descriptive of the semantics type, etc.), the media guidance application may query a semantics table (e.g., Table 1) to identify one or more semantics types based at least in part on a data type corresponding to at least a subset of the plurality of data values of other data rows. Based on the query, the data value of “MEX” may refer to a geographical code or a time zone. Or the data value of “23:35,” “22:00,” etc. may refer to a semantics type of time. The media guidance application may then refine the one or more semantics types based on a context of the tabular data to determine a semantics type for the respective column.

For example, the media guidance application may extract a plurality of keywords descriptive of the context of the tabular data from textual content of the electronic document, e.g., “broadcast schedule information” from the caption of the table. For each semantic type from the one or more semantics types, the media guidance application may determine an overlap percentage with the plurality of keywords. The media guidance application may then identify a semantics type that has the highest overlap percentage with the plurality of keywords as the semantics type for the respective column. In this example, for data values of “22:00,” “23:35,” etc. in the second column of table 100, the semantics type may be a broadcast time based on the keyword of the document “broadcast schedule information.” Specifically, as the header row 101 has a data value of “MEX,” the media guidance application may use the header value “MEX” to identify a semantics type relating to time zone and thus identify the column under the header “MEX” as having a semantics type of broadcast time in the time zone of MEX.

In some embodiments, the media guidance application may determine whether the identified header row contains calendar elements. The media guidance application may extract data values from the cells of the header row, and determine whether these data values have a data format of a calendar date, or match any of previously stored calendar date attributes. For example, if data values of the header row contain “Monday,” “Tuesday,” “Wednesday,” etc., the media guidance application may determine that the data values match attributes of a weekly calendar. The media guidance application may identify the table as containing calendar data. When the table is identified as containing calendar data, the media guidance application may read data values from each respective cell within each column as an event for the date that the respective cell represents. The media guidance application may not need to determine semantics of the column type, as each column represents an event for a respective date.

In some embodiments, the media guidance application may determine the column type for every column in the table. The media guidance application may capture a column signature using the values across all data rows for each column, and the corresponding header value if a header row was detected. For example, in Table 100, under the column “MEX,” all the values “22:00,” “23:35,” “01:10,” etc., may be used to generate a hash signature that corresponds to the column under “MEX.” The media guidance application may then use the column signature to predict the semantics or type of the values in the column. The prediction may be based on domain specific rules or by using a machine learning system that has been trained with signatures of training data for the different types of columns in the domain.

For example, if the media guidance application does not identify any previously stored attribute name that corresponds to the value “MEX,” the media guidance application may read a number of values within the same column corresponding to the cell that contains the value “MEX.” The media guidance application may then process the values within the same column of “MEX,” e.g., “22:00” from row 102, “23:35” from row 103, etc., and generate a hash signature out of the values. The media guidance application may then identify that the hash signature corresponding to the column under “MEX” is similar to a signature relating to air time of a television program, and thus may identify the column under “MEX” as relating to air times of a program. The media guidance application may then move forward to process columns under “COL,” “VEN,” “ARG,” and/or the like, and may similarly identify these columns are related to air times of a television program based on their respective column signatures. The media guidance application may then derive that the column with a header field of three letters indicative of an acronym of a country/region name, e.g., “MEX,” “COL,” etc., and a column of values indicative of times, indicates air times in a country or region. The derivation may be obtained via user feedback, or previously established training data.

In some embodiments, upon identifying the type of each respective column, and the header row if there is any, for each row, the media guidance application may extract every value that corresponds to a column and save the value in a data format that corresponds to the attribute or field that the column represents, e.g., in storage 408 in FIG. 4 or at media guidance data source 518 via communications network 514 in FIG. 5. For example, in table 100, values under column “MEX” may be saved in a time format, and values under column “Title” may be saved as text strings. The media guidance application may then play any media asset based on the saved information from table 100.

In some embodiments, the media guidance application may correlate multiple tables in the same document (e.g., multiple tabs in the same spreadsheet), multiple tables across different documents to determine the semantics of the columns of the tables by analyze rows in the tables in a similar manner as described in relation to FIG. 1. For example, for tables across multiple documents, the media guidance application may first determine that the tables in the multiple documents may be related based on a relevance between the documents (e.g., similar titles, attachments in the same email trail, etc.).

FIGS. 2-3 show illustrative display screens that may be used to provide media guidance data. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

It should be noted that embodiments described in relation to FIG. 1 or any step thereof could be performed on, or provided by, any of the devices shown in, or described with respect to, FIGS. 4-5. For example, any of processes discussed in relation to FIG. 1 may be executed by control circuitry 404 (FIG. 4) as instructed by control circuitry implemented on user equipment 502, 504, 506 (FIG. 5) for detecting semantics of the columns in table 100.

FIG. 2 shows illustrative grid of a program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306, 308, 310, and 312 as broadcast program listings. In display 300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308, 310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be an EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

FIGS. 6A-6B depict an illustrative flowchart of a process for automatically detecting semantics of columns in a data table to determine a data concept that each column represents, in accordance with some embodiments of the disclosure. Process 600 may be executed by control circuitry 404 (e.g., in a manner instructed to control circuitry 404 by the media guidance application). Control circuitry 404 may be part of user equipment (e.g., user television equipment 502, user computer equipment 504, and/or wireless communications device 506), or of a remote server separated from the user equipment by way of communications network 514.

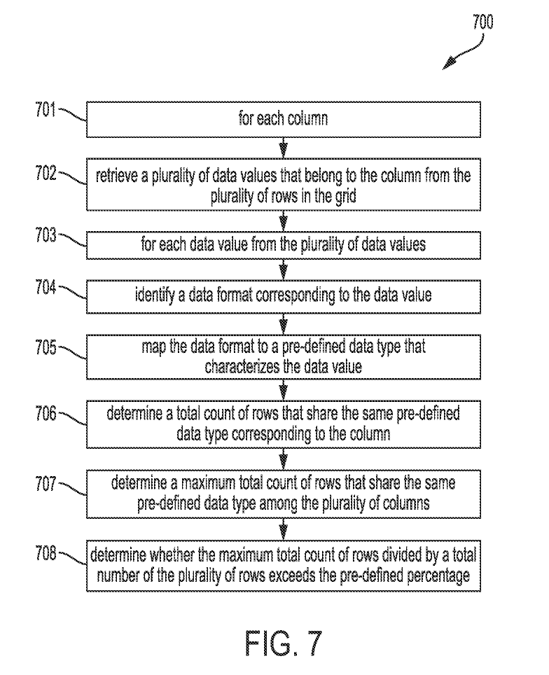

Process 600 begins at 601, where control circuitry 404 receives, via the I/O path 402 described in FIG. 4, an electronic document containing a grid, e.g., from data source 518 via the communications network 514 in FIG. 5. At 602, control circuitry 404 determines whether the grid contains tabular data, e.g., whether the grid is defined by a table object, as discussed in relation to FIG. 1. At 603, in response to determining that the grid contains tabular data, control circuitry 404 identifies a plurality of rows (e.g., 101-108 of table 100 in FIG. 1) and a plurality of columns from the tabular data. At 604, control circuit 404 determines whether a portion of the plurality of rows that share the same data type exceeds a pre-defined percentage. For example, control circuitry 404 determine for each column, whether the majority of the data rows has the same data type such that the column may reflect a semantics type of data, as further discussed in FIG. 7. At 605, process 600 stops if any portion of the plurality of rows that share the same data type does not exceed the pre-defined percentage, e.g., the rows of data do not represent the same concept of data values. At 605, process 600 continues to 606, if a portion of the plurality of rows that share the same data type exceeds the pre-defined percentage, where control circuitry 404 compares a first row (e.g., row 101 of table 100 in FIG. 1) of the grid and other rows of the grid (e.g., rows 102-108 of table 100 in FIG. 1).

At 607, process continues to 608 if the first row of the grid has a different data type from other rows of the grid, where control circuitry 404 identifies the first row of the grid as the header row. For example, control circuitry 404 identifies that for the first column in table 100 in FIG. 1, the first row 101 of “Date” has a data type or format of a textual word, while other rows 102-108 have a data type indicating a date. At 609, control circuitry 404 determines whether a respective data value in the header row corresponding to a respective column indicates a semantics type of the respective column. For example, control circuitry 404 determines that the data value “Date” at row 101 indicates that the column has a semantics indicating a calendar date.

At 610, process 610 continues to 611, if the data value from the header row describes a semantics type for the column, where control circuitry 404 identifies a pre-stored data format, e.g., from storage 408 as described in FIG. 4, or data source 518 as described in FIG. 5, corresponding to the semantics type, e.g., a format of “MM-DD-YYYY” for the semantics type of a calendar date.

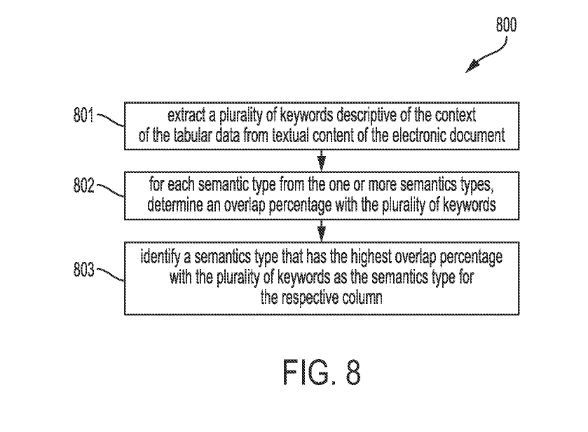

At 607 where the data type of the first row is not different from other rows, or at 610 where the data value from the hear row is not descriptive of a semantics type of the column (e.g., a value of “MEX” is not descriptive of the semantics type, etc.), process 600 continues to 612, where control circuitry 404 queries a semantics table (e.g., Table 1) to identify one or more semantics types based at least in part on a data type corresponding to at least a subset of the plurality of data values of other data rows. At 613, control circuitry 613 refines the one or more semantics types based on a context of the tabular data to determine a semantics type for the respective column, as further described in relation to FIG. 8.

Process 600 continues from 610 or 613 to 614, where control circuitry 404 stores, e.g., at storage 408 in FIG. 4, or data source 518 via communications network 514 in FIG. 5, data values corresponding to each respective column in the data format compliant with the semantics type.

FIG. 7 depicts an illustrative flowchart of a process for determining whether a portion of the plurality of rows that share a same data type exceeds a pre-defined percentage (e.g., 604 in FIG. 6A), in accordance with some embodiments of the disclosure. Process 700 may be executed by control circuitry 404 (e.g., in a manner instructed to control circuitry 404 by the media guidance application). Control circuitry 404 may be part of user equipment (e.g., user television equipment 502, user computer equipment 504, and/or wireless communications device 506), or of a remote server separated from the user equipment by way of communications network 514.

Process 700 begins at 701, where control circuitry 404, for each column, retrieves a plurality of data values that belong to the column from the plurality of rows in the grid at 702. At 703, for each data value from the plurality of data values, control circuitry 404 identifies a data format corresponding to the data value, and maps the data format to a pre-defined data type that characterizes the data value at 704. For example, for the data value of “Date” in row 101 in table 100 of FIG. 1, control circuitry 404 identifies a data format of text, and maps the textual data format to a data type as a descriptor. For another example, for data value of “Jan. 1, 2017” in row 102 in table 100 of FIG. 1, control circuitry 404 identifies a data format of a calendar date, and maps the calendar date format to a date type as schedule-related information. At 706, control circuitry 404 determines a total count of rows that share the same pre-defined data type corresponding to the column. At 707, control circuitry 404 determines a maximum total count of rows that share the same pre-defined data type among the plurality of columns, and determines whether the maximum total count of rows divided by a total number of the plurality of rows exceeds the pre-defined percentage. For example, in table 100 in FIG. 1, control circuitry 404 determines that for the first column, all data rows 102-108 other than the first row 101 share the same data type of schedule-related information.

FIG. 8 depicts an illustrative flowchart of a process for refining one or more semantics types based on a context of the tabular data to determine a semantics type for the respective column, in accordance with some embodiments of the disclosure. Process 800 may be executed by control circuitry 404 (e.g., in a manner instructed to control circuitry 404 by the media guidance application). Control circuitry 404 may be part of user equipment (e.g., user television equipment 502, user computer equipment 504, and/or wireless communications device 506), or of a remote server separated from the user equipment by way of communications network 514.

Process 800 begins at 801, where control circuitry 404 extracts a plurality of keywords descriptive of the context of the tabular data from textual content of the electronic document, e.g., “broadcast schedule information” from the caption of the table 100 in FIG. 1. For each semantic type from the one or more semantics types, at 802, control circuitry 404 determines an overlap percentage with the plurality of keywords. At 803, control circuitry 404 identifies a semantics type that has the highest overlap percentage with the plurality of keywords as the semantics type for the respective column.

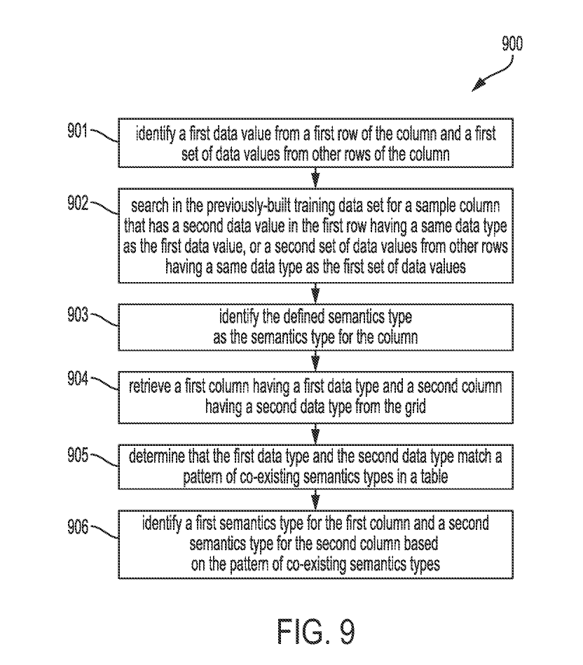

FIG. 9 depicts an illustrative flowchart of a process for determining the semantics type of each column based on a training data set, in accordance with some embodiments of the disclosure. Process 900 may be executed by control circuitry 404 (e.g., in a manner instructed to control circuitry 404 by the media guidance application). Control circuitry 404 may be part of user equipment (e.g., user television equipment 502, user computer equipment 504, and/or wireless communications device 506), or of a remote server separated from the user equipment by way of communications network 514.

Process 900 begins at 901, where control circuitry 404 identifies a first data value from a first row of the column (e.g., “Date” as in row 101 of table 100 in FIG. 1) and a first set of data values from other rows of the column (e.g., “Jan. 1, 2017” in row 102 of table 100 in FIG. 1). At 902, control circuitry 404 searches in the previously-built training data set for a sample column that has a second data value in the first row having a same data type as the first data value, or a second set of data values from other rows having a same data type as the first set of data values. At 903, control circuitry 404 identifies the defined semantics type as the semantics type for the column.

In another implementation, at 904, control circuitry 404 retrieves a first column having a first data type and a second column having a second data type from the grid. At 905, control circuitry 404 determines that the first data type and the second data type match a pattern of co-existing semantics types in a table, and identifies a first semantics type for the first column and a second semantics type for the second column based on the pattern of co-existing semantics types. For example, as shown in FIG. 1, table 100 has columns of schedule information of the same data type with the same data type in the header row, e.g., a geographical code. The training data may indicate that such pattern of several adjacent columns under the header row of geographical codes indicate a semantics type of a time in a specific time zone.

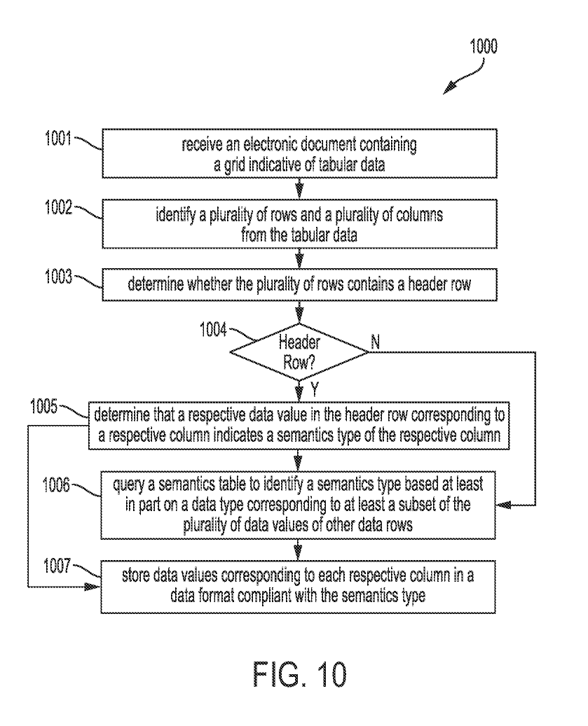

FIG. 10 depicts an illustrative flowchart of a process for detecting semantics of columns in a data table, in accordance with some embodiments of the disclosure. Process 1000 may be executed by control circuitry 404 (e.g., in a manner instructed to control circuitry 404 by the media guidance application). Control circuitry 404 may be part of user equipment (e.g., user television equipment 502, user computer equipment 504, and/or wireless communications device 506), or of a remote server separated from the user equipment by way of communications network 514.

Process 1000 begins at 1001, where control circuitry 404 receives an electronic document containing a grid indicative of tabular data. At 1002, control circuitry 404 identifies a plurality of rows and a plurality of columns from the tabular data. At 1003, control circuitry 404 determines whether the plurality of rows contains a header row. At 1004, if the plurality of rows contains a header row, process 1000 continues to 1005, where control circuitry 404 determines that a respective data value in the header row corresponding to a respective column indicates a semantics type of the respective column. At 1004, if the plurality of rows does not contain a header row, process 1000 continues to 1006, where control circuitry 404 queries a semantics table to identify a semantics type based at least in part on a data type corresponding to at least a subset of the plurality of data values of other data rows. At 1007, control circuitry 404 stores, e.g., at storage 404 in FIG. 4 or data source 518 via communications network 514 in FIG. 5, data values corresponding to each respective column in a data format compliant with the semantics type.

It is contemplated that the steps or descriptions of each of FIGS. 1-10 may be used with any other embodiment of this disclosure. In addition, the steps and descriptions described in relation to FIGS. 1-5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-10 could be used to perform one or more of the steps described herein.

It will be apparent to those of ordinary skill in the art that methods involved in the present disclosure may be embodied in a computer program product that includes a computer-usable and/or readable medium. For example, such a computer-usable medium may consist of a read-only memory device, such as a CD-ROM disk or conventional ROM device, or a random access memory, such as a hard drive device or a computer diskette, having a computer-readable program code stored thereon. It should also be understood that methods, techniques, and processes involved in the present disclosure may be executed using processing circuitry. For instance, annotating each respective portion of the media asset may be performed, e.g., by processing circuitry 406 of FIG. 4. The processing circuitry, for instance, may be a general purpose processor, a customized integrated circuit (e.g., an ASIC), or a field-programmable gate array (FPGA) within user equipment 400, media content source 516, or media guidance data source 518. For example, each identified semantics of each column of the tabular data, as described herein, may be stored in, and retrieved from, storage 408 of FIG. 4, or media guidance data source 518 of FIG. 5. Furthermore, processing circuitry, or a computer program, may update configuration data of the media guidance application, which may be stored within storage 408 of FIG. 4 or media guidance data source 518 of FIG. 5.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

While some portions of this disclosure may make reference to “convention,” any such reference is merely for the purpose of providing context to the invention(s) of the instant disclosure, and does not form any admission as to what constitutes the state of the art.

1. (canceled)

2. A method for automatically detecting semantics of columns in a data table to determine a data concept that each column represents, the method comprising:
receiving an electronic document containing a grid;
determining whether the grid contains tabular data;
in response to determining that the grid contains tabular data, identifying a plurality of rows and a plurality of columns from the tabular data;
determining whether a portion of the plurality of rows that share a same data type exceeds a pre-defined percentage;
in response to determining that the portion of the plurality of rows that share the same data type exceeds the pre-defined percentage, determining whether the plurality of rows contains a header row by comparing a first row of the grid and other rows of the grid;
in response to determining that the first row of the grid has a different data type from the other rows of the grid, identifying the first row of the grid as the header row;
in response to determining that the plurality of rows contains the header row:
determining whether a respective data value in the header row corresponding to a respective column indicates a semantics type of the respective column,
wherein the semantics type represents a data concept that data values within the respective column correspond to;
in response to determining that the respective data value corresponding to the respective column in the header row indicates the semantics type of the respective column, identifying a pre-stored data format corresponding to the semantics type; and
in response to determining that the plurality of rows does not contain a header row, or the respective data value in the header row corresponding to the respective column does not indicate the semantics type of the respective column:
querying a semantics table to identify one or more semantics types based at least in part on a data type corresponding to at least a subset of the plurality of data values of other data rows;
refining the one or more semantics types based on a context of the tabular data to determine a semantics type for the respective column; and
storing data values corresponding to each respective column in the data format compliant with the semantics type.

3. The method of claim 2, wherein the determining whether the grid contains tabular data comprises:
determining whether grid corresponds to a table object defined in a structured document model;
in response to determining that the grid does not correspond to a table object defined in a structured document model:
determining whether the grid contains a number of rows and a number of columns that are compliant with a table format; and
in response to determining that the grid contains a number of rows and a number of columns that are compliant with a table format, translating the grid to tabular data in a form of the table object.

4. The method of claim 2, wherein the determining whether a portion of the plurality of rows that share a same data type exceeds a pre-defined percentage comprises:
for each column:
retrieving a plurality of data values that belong to the column from the plurality of rows in the grid;
for each data value from the plurality of data values,
identifying a data format corresponding to the data value; and
mapping the data format to a pre-defined data type that characterizes the data value;
determining a total count of rows that share the same pre-defined data type corresponding to the column; and
determining a maximum total count of rows that share the same pre-defined data type among the plurality of columns; and
determining whether the maximum total count of rows divided by a total number of the plurality of rows exceeds the pre-defined percentage.

5. The method of claim 2, wherein the determining whether the plurality of rows contains a header row by comparing a first row of the grid and other rows of the grid comprises:
retrieving a first data value in a first row of the grid and a plurality of data values of other data rows in a same column with the first data value;
determining that the first data value corresponds to a first data type;
determining that a subset of the plurality of data values of other data rows correspond to a second data type,
wherein a total count of the subset of the plurality of data values divided by a total number of the plurality of rows exceeds the pre-defined percentage;
comparing the first data type with the second data type;
in response to determining that the first data type is different from the second data type, identifying the first row of the grid as the header row.

6. The method of claim 2, wherein the determining whether a respective data value in the header row corresponding to a respective column indicates a semantics type of the respective column comprises:
querying a database of previously stored semantics types based on the respective data value;
obtaining one or more previously stored semantics types from the querying;
for each obtained previously stored semantics type, determining whether the obtained previously stored semantics type matches a data type corresponding to data values from the other rows of the grid in the respective column; and
in response to determining that at least one obtained previously stored semantics type matches the data type corresponding to data values from the other rows of the grid in the respective column, identifies the at least one obtained previously stored semantics type as the semantics type of the respective column.

7. The method of claim 2, wherein the refining the one or more semantics types based on a context of the tabular data to determine a semantics type for the respective column comprises:
extracting a plurality of keywords descriptive of the context of the tabular data from textual content of the electronic document;
for each semantic type from the one or more semantics types, determining an overlap percentage with the plurality of keywords; and
identifying a semantics type that has the highest overlap percentage with the plurality of keywords as the semantics type for the respective column.

8. The method of claim 2, wherein the refining the one or more semantics types based on a context of the tabular data to determine a semantics type for the respective column comprises:
identifying another column from the grid, wherein the other column has a defined semantics type; and
for each semantics type from the one or more semantics types, determining whether the semantics type for the respective column is related to the defined semantics type based on a previously stored pattern of co-existing semantics types.

9. The method of claim 2, further comprising:
in response to determining that the plurality of rows does not contain a header row, or the respective data value in the header row corresponding to the respective column does not indicate the semantics type of the respective column:
identifying a first column and a second column from the grid, wherein a first data value from the first column and a second data value from the second column in a same row share a same data type; and
determining that the first column and the second column share a same semantics type.

10. The method of claim 2, further comprising:
determining the semantics type of each column based on a training data set by:
identifying a first data value from a first row of the column and a first set of data values from other rows of the column;
searching in the previously-built training data set for a sample column that has a second data value in the first row having a same data type as the first data value, or a second set of data values from other rows having a same data type as the first set of data values,
wherein the sample column corresponds to a defined semantics type;
in response to determining that the second data value has the same data type with the first data value, and at least a subset of the second set of data values have the same data type with the first set of data values, identify the defined semantics type as the semantics type for the column.

11. The method of claim 10, further comprising:
generating a new sample column including the second data value from the first row, the second set of data values from other rows and the semantics type for the column; and
adding the new sample column into the training data set.

12. A system for automatically detecting semantics of columns in a data table to determine a data concept that each column represents, the system comprising:
memory;
communication circuitry; and
control circuitry configured to:
receive, via the communication circuitry, an electronic document containing a grid;
determine whether the grid contains tabular data;
in response to determining that the grid contains tabular data, identify a plurality of rows and a plurality of columns from the tabular data;
determine whether a portion of the plurality of rows that share a same data type exceeds a pre-defined percentage;
in response to determining that the portion of the plurality of rows that share the same data type exceeds the pre-defined percentage, determine whether the plurality of rows contains a header row by comparing a first row of the grid and other rows of the grid;
in response to determining that the first row of the grid has a different data type from the other rows of the grid, identify the first row of the grid as the header row;
in response to determining that the plurality of rows contains the header row:
determine whether a respective data value in the header row corresponding to a respective column indicates a semantics type of the respective column,
wherein the semantics type represents a data concept that data values within the respective column correspond to;
in response to determining that the respective data value corresponding to the respective column in the header row indicates the semantics type of the respective column, identify a pre-stored data format corresponding to the semantics type; and
in response to determining that the plurality of rows does not contain a header row, or the respective data value in the header row corresponding to the respective column does not indicate the semantics type of the respective column:
query a semantics table to identify one or more semantics types based at least in part on a data type corresponding to at least a subset of the plurality of data values of other data rows;
refine the one or more semantics types based on a context of the tabular data to determine a semantics type for the respective column; and
store, at the memory, data values corresponding to each respective column in the data format compliant with the semantics type.

13. The system of claim 12, wherein the control circuitry, when determining whether the grid contains tabular data, is further configured to:
determine whether grid corresponds to a table object defined in a structured document model;
in response to determining that the grid does not correspond to a table object defined in a structured document model:
determine whether the grid contains a number of rows and a number of columns that are compliant with a table format; and
in response to determining that the grid contains a number of rows and a number of columns that are compliant with a table format, translate the grid to tabular data in a form of the table object.

14. The system of claim 12, wherein the control circuitry, when determining whether a portion of the plurality of rows that share a same data type exceeds a pre-defined percentage, is further configured to:
for each column:
retrieve a plurality of data values that belong to the column from the plurality of rows in the grid;
for each data value from the plurality of data values,
identify a data format corresponding to the data value; and
map the data format to a pre-defined data type that characterizes the data value;
determine a total count of rows that share the same pre-defined data type corresponding to the column; and
determine a maximum total count of rows that share the same pre-defined data type among the plurality of columns; and
determine whether the maximum total count of rows divided by a total number of the plurality of rows exceeds the pre-defined percentage.

15. The system of claim 12, wherein the control circuitry, when determining whether the plurality of rows contains a header row by comparing a first row of the grid and other rows of the grid, is further configured to:
retrieve a first data value in a first row of the grid and a plurality of data values of other data rows in a same column with the first data value;
determine that the first data value corresponds to a first data type;
determine that a subset of the plurality of data values of other data rows correspond to a second data type,
wherein a total count of the subset of the plurality of data values divided by a total number of the plurality of rows exceeds the pre-defined percentage;
compare the first data type with the second data type;
in response to determining that the first data type is different from the second data type, identify the first row of the grid as the header row.

16. The system of claim 12, wherein the control circuitry, when determining whether a respective data value in the header row corresponding to a respective column indicates a semantics type of the respective column, is further configured to:
query a database of previously stored semantics types based on the respective data value;
obtain one or more previously stored semantics types from the querying;
for each obtained previously stored semantics type, determine whether the obtained previously stored semantics type matches a data type corresponding to data values from the other rows of the grid in the respective column; and
in response to determining that at least one obtained previously stored semantics type matches the data type corresponding to data values from the other rows of the grid in the respective column, identify the at least one obtained previously stored semantics type as the semantics type of the respective column.

17. The system of claim 12, wherein the control circuitry, when refining the one or more semantics types based on a context of the tabular data to determine a semantics type for the respective column, is further configured to:
extract a plurality of keywords descriptive of the context of the tabular data from textual content of the electronic document;
for each semantic type from the one or more semantics types, determine an overlap percentage with the plurality of keywords; and
identify a semantics type that has the highest overlap percentage with the plurality of keywords as the semantics type for the respective column.

18. The system of claim 12, wherein the control circuitry, when refining the one or more semantics types based on a context of the tabular data to determine a semantics type for the respective column, is further configured to:
identify another column from the grid, wherein the other column has a defined semantics type; and
for each semantics type from the one or more semantics types, determine whether the semantics type for the respective column is related to the defined semantics type based on a previously stored pattern of co-existing semantics types.

19. The system of claim 12, wherein the control circuitry is further configured to:
in response to determining that the plurality of rows does not contain a header row, or the respective data value in the header row corresponding to the respective column does not indicate the semantics type of the respective column:
identify a first column and a second column from the grid, wherein a first data value from the first column and a second data value from the second column in a same row share a same data type; and
determine that the first column and the second column share a same semantics type.

20. The system of claim 12, wherein the control circuitry is further configured to:
determine the semantics type of each column based on a training data set by:
identifying a first data value from a first row of the column and a first set of data values from other rows of the column;
searching in the previously-built training data set for a sample column that has a second data value in the first row having a same data type as the first data value, or a second set of data values from other rows having a same data type as the first set of data values,
wherein the sample column corresponds to a defined semantics type;
in response to determining that the second data value has the same data type with the first data value, and at least a subset of the second set of data values have the same data type with the first set of data values, identify the defined semantics type as the semantics type for the column.

21. The system of claim 20, wherein the control circuitry is further configured to:
generate a new sample column including the second data value from the first row, the second set of data values from other rows and the semantics type for the column; and
adding the new sample column into the training data set.

22.-51. (canceled)
